(19) United States
(12) Patent Application Publication
(10) Pub. No.: US 2006/0239710 A1
(43) Pub. Date: Oct. 26, 2006

(54) Emissions elimination for small sized toner

(75) Inventors: Ajay Kumar, Fairport, NY (US); Keith A. Nau, Webster, NY (US); Hirotsugu Oba, Webster, NY (US); Jonathan D. Sadik, Rochester, NY (US); David A. Reed, Rochester, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 11/114,496

(22) Filed: Apr. 26, 2005

(51) Int. Cl. G03G 15/08

(52) U.S. Cl. 399/103

(57) ABSTRACT

A seal device for a developer system in an electrophotographic printing machine, including: a developer housing containing toner particles; a donor member rotatably mounted in the housing for transferring toner particles to a latent image on a photoreceptive member moving in a process direction; a toner emission system for collecting toner particles with a vacuum; and a seal member, mounted to each end of the housing and in contact with the photoreceptive member, to retain side ways migrating toner particles from escaping each end of the housing thereby substantially reducing toner particles from being emitted past the housing.

### BACKGROUND

This invention relates generally to the development of electrostatic images, and more particularly concerns a development apparatus having a developer seal system and an active airflow system which minimizes the escape of airborne particles therefrom.

Generally, the process of electrophotographic printing includes sensitizing a photoconductive surface by charging it to a substantially uniform potential. The charge is selectively dissipated in accordance with a pattern of activating radiation corresponding to a desired image. The selective dissipation of the charge leaves a latent charge pattern that is developed by bringing a developer material into contact therewith. This process forms a toner powder image on the photoconductive surface which is subsequently transferred to a copy sheet. Finally, the powder image is heated to permanently affix it to the copy sheet in image configuration.

Two component and single component developer materials are commonly used. A typical two component developer material comprises magnetic carrier granules having toner particles adhering triboelectrically thereto. A single component developer material typically comprises toner particles having an electrostatic charge so that they will be attracted to, and adhere to, the latent image on the photoconductive surface.

There are various known development systems for bringing toner particles to a latent image on a photoconductive surface. Single component development systems use a donor roll for transporting charged toner to the development nip defined by the donor roll and the photoconductive surface. The toner is developed on the latent image recorded on the photoconductive surface by a combination of mechanical scavengeless development. A scavengeless development system uses a donor roll with a plurality of electrode wires closely spaced therefrom in the development zone. An AC voltage is applied to the wires detaching the toner from the donor roll and forming a toner powder cloud in the development zone. The electrostatic fields generated by the latent image attract toner from the toner cloud to develop the latent image.

In another type of scavengeless system, a magnetic developer roll attracts developer from a reservoir. The developer includes carrier and toner. The toner is attracted from the carrier to a donor roll. The donor roll then carries the toner into proximity with the latent image.

A problem, associated most directly with either development system, is the inadvertent escape of developing material, and, in particular, dry toner particles from the developer housing. Airborne toner particles carrying an electrostatic charge are readily attracted to various surfaces within the electrostatographic apparatus outside of the developer housing which can result in the contamination of various processing stations and machine components. Moreover, since the charge on the toner particles is not controlled, escaping toner particles can be developed on the photoreceptor, producing a background image on the reproduction of the image. Contamination caused by the escape of developing material adversely effects machine reliability and performance as well as print quality leading to unscheduled maintenance and repair by skilled field service technicians.

The issues involving developing material escape and the resultant problems associated therewith are well-recognized in the art of electrostatographic printing. Generally, therefore, a typical developer housing will include a seal or other physical barrier for preventing the migration of developing material outside of the developer housing. However, the peculiar characteristics of developing material and a general requirement for safeguarding the photoconductive surface of the photoreceptive member precludes the use of many configurations or existing materials which might otherwise provide an effective barrier for preventing the escape of developer material or other airborne contaminants from the developer housing.

Various solutions for addressing the problem of developing material escape and contamination have been suggested and utilized in which the developer housing is maintained at negative pressure relative to the ambient environment of the electrophotographic machine to generate an airflow that is directed out of the developer housing.

Typically, such systems for providing negative pressure also include an air ducting apparatus for directing the induced airflow into a filter or other safe area. Such systems have been very successful in preventing the escape of airborne particles from a developer housing to eliminate the problem of developing material contamination in electrophotographic machines.

However, Applicants have found that such systems for providing negative pressure while very effective for toner particles greater than XX um, offer rather poor performance for EA type toner having a size of. 7.0 um or less the ability to collect escaping toner with just negative pressure has become inadequate.

### SUMMARY

There is provided a seal device for a developer system in an electrophotographic printing machine, including: a developer housing containing toner particles; a donor member rotatably mounted in said housing for transferring toner particles to a latent image on a photoreceptive member moving in a process direction; a toner emission system for collecting toner particles with a vacuum; and a seal member, mounted to each end of said housing and in contact with said photoreceptive member, to retain side ways migrating toner particles from escaping each end of said housing thereby substantially reducing toner particles from being emitted past said housing.

### BRIEF DESCRIPTION OF THE DRAWINGS

FIG. 1 is a schematic elevational view of an illustrative electrophotographic printing machine incorporating developer unit having the features of the present invention therein.

FIG. 2 is a schematic elevational view showing one embodiment of the developer unit used in the FIG. 1 printing machine.

FIG. 3 is an enlarged illustration of the present disclosure.

FIG. 4 is a top view of the developer unit used in the FIG. 2.

### DETAILED DESCRIPTION

While the present invention will be described in connection with a preferred embodiment thereof, it will be understood that it is not intended to limit the invention to that embodiment. On the contrary, it is intended to cover all alternatives, modifications, and equivalents as may be included within the spirit and scope of the invention as defined by the appended claims.

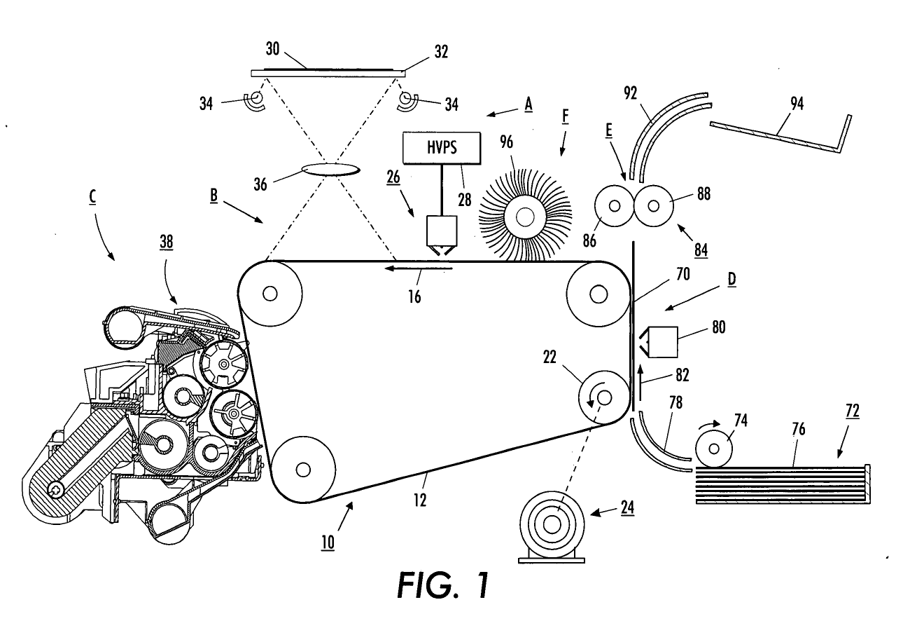

Inasmuch as the art of electrophotographic printing is well known, the various processing stations employed in the FIG. 1 printing machine will be shown hereinafter schematically and their operation described briefly with reference thereto.

Referring initially to FIG. 1, there is shown an illustrative electrophotographic printing machine incorporating the development apparatus of the present invention therein. The electrophotographic printing machine employs a belt 10 having a photoconductive surface 12 deposited on a conductive substrate. Preferably, photoconductive surface 12 is made from selenium alloy. The conductive substrate is made preferably from an aluminum alloy that is electrically grounded. One skilled in the art will appreciate that any suitable photoconductive belt may be used. Belt 10 moves in the direction of arrow 16 to advance successive portions of photoconductive surface 12 sequentially through the various processing stations disposed of throughout the path of movement thereof. Motor 24 rotates belt 10 in the direction of arrow 16. Roller 22 is coupled to motor 24 by suitable means, such as a drive belt.

Initially, a portion of belt 10 passes through charging station A. At charging station A, a corona generating device, indicated generally by the reference numeral 26 charges photoconductive surface 12 to a relatively high, substantially uniform potential. High voltage power supply 28 is coupled to corona generating device 26 to charge photoconductive surface 12 of belt 10. After photoconductive surface 12 of belt 10 is charged, the charged portion thereof is advanced through exposure station B.

At exposure station B, an original document 30 is placed face down upon a transparent platen 32. Lamps 34 flash light rays onto original document 30. The light rays reflected from original document 30 are transmitted through lens 36 to form a light image thereof. Lens 36 focuses this light image onto the charged portion of photoconductive surface 12 to selectively dissipate the charge thereon. This records an electrostatic latent image on photoconductive surface 12 that corresponds to the informational areas contained within original document 30.

After the electrostatic latent image has been recorded on photoconductive surface 12, belt 10 advances the latent image to development station C. At development station C, a developer unit, indicated generally by the reference numeral 38, develops the latent image recorded on the photoconductive surface. Preferably, developer unit 38 includes donor rolls 40 and 41 and electrode wires 42. Electrode wires 42 are electrically biased relative to donor rolls 40 and 41 to detach toner therefrom so as to form a toner powder cloud 43 in the gap between the donor rolls and the photoconductive surface. The latent image attracts toner particles from the toner powder cloud 43 forming a toner powder image thereon. Donor rolls 40 and 41 are mounted, at least partially, in the chamber of the developer housing. The chamber in the developer housing stores a supply of developer material. In one embodiment the developer material is a single component development material of toner particles, whereas in another, the developer material includes at least toner and carrier.

With continued reference to FIG. 1, after the electrostatic latent image is developed, belt 10 advances the toner powder image to transfer station D. A copy sheet 70 is advanced to transfer station D by sheet feeding apparatus 72. Preferably, sheet feeding apparatus 72 includes a feed roll 74 contacting the uppermost sheet of stack 76 into chute 78. Chute 78 directs the advancing sheet of support material into contact with photoconductive surface 12 of belt 10 in a timed sequence so that the toner powder image developed thereon contacts the advancing sheet at transfer station D. Transfer station D includes a corona generating device 80 which sprays ions onto the back side of sheet 70. This attracts the toner powder image from photoconductive surface 12 to sheet 70. After transfer, sheet 70 continues to move in the direction of arrow 82 onto a conveyor (not shown) that advances sheet 70 to fusing station E.

Fusing station E includes a fuser assembly, indicated generally by the reference numeral 84, which permanently affixes the transferred powder image to sheet 70. Fuser assembly 84 includes a heated fuser roller 86 and a back-up roller 88. Sheet 70 passes between fuser roller 86 and back-up roller 88 with the toner powder image contacting fuser roller 86. In this manner, the toner powder image is permanently affixed to sheet 70. After fusing, sheet 70 advances through chute 92 to catch tray 94 for subsequent removal from the printing machine by the operator.

After the copy sheet is separated from photoconductive surface 12 of belt 10, the residual toner particles adhering to photoconductive surface 12 are removed therefrom at cleaning station F. Cleaning station F includes a rotatably mounted fibrous brush 96 in contact with photoconductive surface 12. The particles are cleaned from photoconductive surface 12 by the rotation of brush 96 in contact therewith. Subsequent to cleaning, a discharge lamp (not shown) floods photoconductive surface 12 with light to dissipate any residual electrostatic charge remaining thereon prior to the charging thereof for the next successive imaging cycle.

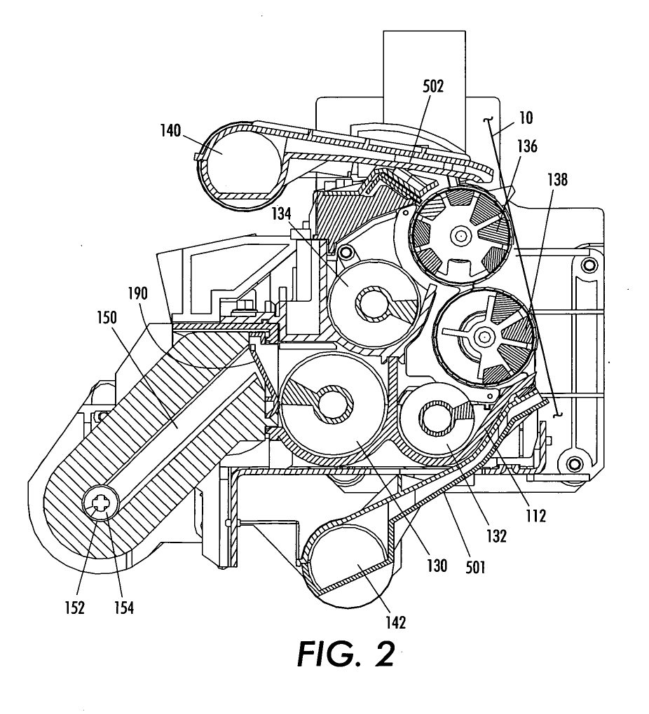

Referring now to FIG. 2, there is shown an embodiment of the present disclosure in greater detail. The development system 38 is a (SCMB) development system includes donor rolls 40 and 41, and magnetic metering roll 46. Roll 46 supplies charged toner to donor rolls 40 and 41. Donor rolls 40 and 41 can be rotated in either the ‘with’ or ‘against’ direction relative to the direction of motion of belt 10. The donor roll is shown rotating in the direction of arrow. Augers 88 and 86 mix developer material, which is supplied to magnetic roll 46.

The developer apparatus 38 further has development electrode. An electrical bias is applied to the development by a power source (not shown). The bias establishes an electrostatic field which is effective in detaching toner from the surface of the donor rolls and forming a toner cloud 43.

A DC bias supply (not shown) establishes an electrostatic field between the photoconductive surface 12 and donor rolls 40 and 41 for attracting the detached toner particles from the cloud to the latent image on the photoconductive surface 12. A DC bias supply (not shown) establishes an electrostatic field between magnetic roll 46 and donor rolls which causes toner particles to be attracted from the magnetic roll to the donor roll. A metering blade portion 100 can be positioned closely adjacent to magnetic roll 46 to maintain the compressed pile height of the developer material on magnetic roll 46 at the desired level.

As successive electrostatic latent images are developed, the toner particles within the developer material are depleted. Augers are mounted rotatably to mix fresh toner particles with the remaining developer material so that the resultant developer material therein is substantially uniform with the concentration of toner particles being optimized.

It is believed that the foregoing description is sufficient for purposes of the present application to illustrate the general operation of an electrophotographic printing machine incorporating the development apparatus of the present disclosure therein.

Referring back to FIG. 2, developer housing also includes a toner emission system which includes manifolds 501 and 502. The location of the two manifold plenum entrances are located above and below the upper and lower donor rolls respectively each manifold is connected to a blower which generates a vacuum to collect toner escaping beyond the toner cloud.

As a result of extensive research on the toner flow patterns in the development zone by Applicants in which printing machines where the developer system utilized 8 um and greater sized toner particles were studied versus printing machines where the same developer system was employed but utilized 7 um and less size toner particles where also studied. It was observed by the Applicants that there was not a sufficient toner contamination problem with developer system utilized 8 um and greater sized toner particles. However, Applicants have found that the amount of escaped toner in the developer system that utilizes 7 um and less size toner particles is sufficient to serve.

In the studied of developer system that utilizes 7 um and less size toner particles, Applicants have found that in developer system that any toner cloud migrating to the top & bottom is captured by Upper and Lower Manifolds. However, toner cloud is also generated during the transfer of Developer from Upper to Lower donor rolls. The toner cloud between the rolls cannot go up or down because of the physical barrier created by the contact of donor rolls and photoreceptor. Hence, this toner cloud tends to migrate “side-ways” where there is no “air-manifold” to handle the toner-cloud therefore toner can escape.

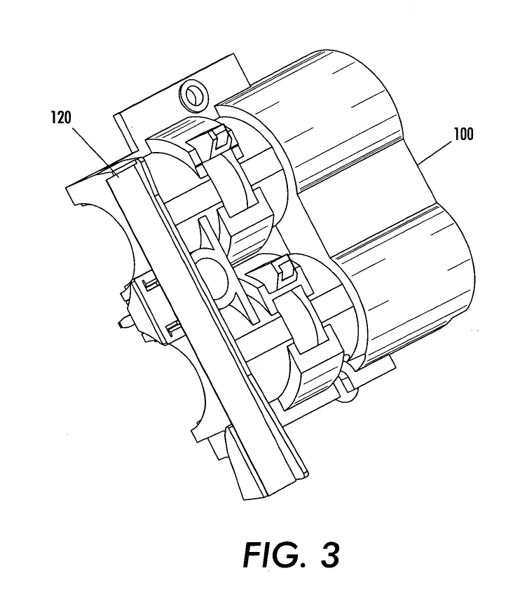

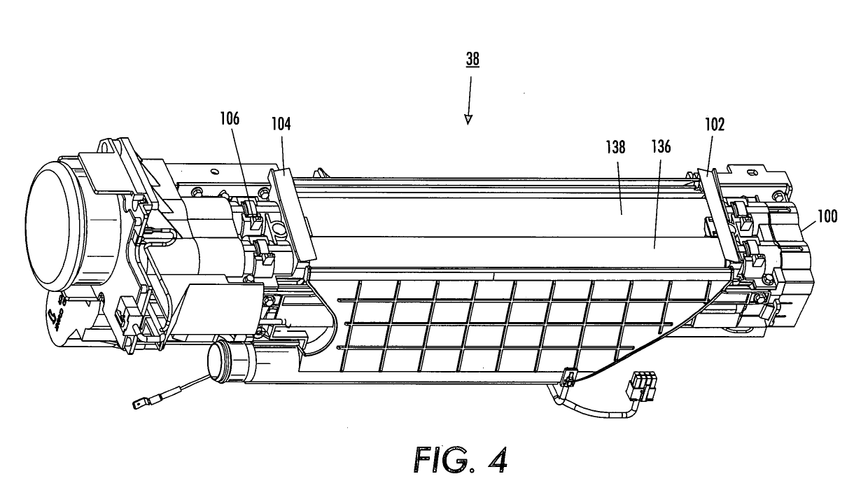

To solve this problem of “side-ways” migrating toner, Applicants have integrated seals 102 and 104 on inboard side bracket 106 and out board side bracket 100 as shown in FIG. 3. Inboard side bracket 106 and out board side bracket 100 retained the donor rolls 41 and 42 within the developer housing. Inboard side bracket 106 and out board side bracket 100 have integral ribs form therein that do not touch the photoconductive surface. Seals 102 and 104 which may be composed of an urethane-film material will interfere with the photoconductive surface as shown in FIG. 4. Preferably the seal is 0.13±0.03 thick urethane with a 0.13 thick clear polyester carrier strip and two layers of 0.13 thick adhesive. The seals (angle, interference with Photoreceptor) are optimized to prevent any scratches on the photoreceptor as well robust against tolerance stack up. This prevents and side migration of the toner clouds. Hence, prevents contamination.

It is, therefore, apparent that there has been provided in accordance with the present invention that fully satisfies the aims and advantages hereinbefore set forth. While this invention has been described in conjunction with a specific embodiment thereof, it is evident that many alternatives, modifications, and variations will be apparent to those skilled in the art. Accordingly, it is intended to embrace all such alternatives, modifications and variations that fall within the spirit and broad scope of the appended claims.

1. A seal device for a developer system in an electrophotographic printing machine, comprising:
a developer housing containing toner particles;
a donor member rotatably mounted in said housing for transferring toner particles in a development zone to a latent image on a photoreceptive member moving in a process direction;
a toner emission system, adjacent to said development zone, for collecting stray toner particles with a vacuum; and
a seal member, positioned parallel with the process direction of said photoreceptive member and mounted to each end of said housing and in contact with said photoreceptive member, to retain side ways migrating toner particles from escaping each end of said housing thereby substantially reducing toner particles from being emitted past said housing.

2. A device according to claim 1, wherein said seal comprises a low friction material comprising urethane film.

3. A device according to claim 1, further comprising first and second removable side brackets for holding each end of said donor member mounted in said housing, said first and second removable having said seal member attached thereto.

4. A device according to claim 1, wherein said seal has a thickness 0.13±0.03 mm.

5. (canceled)

6. A device according to claim 1, wherein said donor member includes a first donor roll for transporting toner from said housing to said development zone;
a second donor roll, adjacent to said first donor roll, for transporting toner from said housing to said development zone.

7. A device according to claim 6, further comprising
a first manifold, adjacent to said first donor roll, having an air stream for removing toner emission; and
a second manifold, adjacent to said second roll, having an air stream for removing toner emission near a vicinity thereof.

8. A device according to claim 1, wherein said toner has a particle size of 7 um or less.
